(19) United States
(12) Patent Application Publication
(10) Pub. No.: US 2020/0134109 A1
(43) Pub. Date: Apr. 30, 2020

(54) SYSTEM AND METHOD FOR CALIBRATING SIMULATION MODEL

(71) Applicant: ELECTRONICS AND TELECOMMUNICATIONS RESEARCH INSTITUTE, Daejeon (KR)

(72) Inventors: Chun Hee LEE, Nonsan-si (KR); Eui Hyun PAIK, Daejeon (KR); Dong-Oh KANG, Daejeon (KR); Jang Won BAE, Daejeon (KR); Joon Young JUNG, Daejeon (KR)

(21) Appl. No.: 16/233,276

(22) Filed: Dec. 27, 2018

(30) Foreign Application Priority Data
Oct. 31, 2018 (KR) 10-2018-0132575

(51) Int. Cl. G06F 17/50; G05B 17/02; G06F 16/9038

(52) U.S. Cl. CPC G06F 17/5009; G06F 16/9038; G05B 17/02

(57) ABSTRACT

A system and method for calibrating a simulation model based on a framework. The system includes a calibration parameter value generating processor configured to generate a value of a first calibration parameter for calibrating microdata and a value of a second calibration parameter for calibrating a simulating processor; an initial data generating processor configured to determine a missing value of the microdata based on the value of the first calibration parameter to generate initial data; and the simulating processor configured to simulate based on the initial data and the value of the second calibration parameter.

### CROSS-REFERENCE TO RELATED APPLICATION

This application claims priority to and the benefit of Korean Patent Application No. 10-2018-0132575 filed in the Korean Intellectual Property Office on Oct. 31, 2018, the entire content of which is incorporated herein by reference.

### BACKGROUND OF THE INVENTION

### 1. Field of the Invention

The present invention relates to a system and method for calibrating a simulation model based on a framework.

### 2. Description of Related Art

When developing a simulation model, calibration work is required to improve the accuracy of simulation results.

The simulation model calibration is a process of finding a calibration parameter value with high accuracy by changing various calibration parameter values of the model.

### SUMMARY OF THE INVENTION

According to an embodiment of the present disclosure there is provided a system for calibrating a simulation model based on a framework, the system including: a calibration parameter value generating processor configured to generate a value of a first calibration parameter for calibrating microdata and a value of a second calibration parameter for calibrating a simulating processor; an initial data generating processor configured to determine a missing value of the microdata based on the value of the first calibration parameter to generate initial data; and the simulating processor configured to simulate based on the initial data and the value of the second calibration parameter.

The initial data generating processor may determine the missing value as one of 0, a mean value of one column of the microdata, or a value having a highest occurrence frequency in one column of the microdata, according to the value of the first calibration parameter

The system may further include a displaying processor configured to visualize simulation results for the value of the second calibration parameter.

The displaying processor may visualize the value of the second calibration parameter, accuracy based on results of comparison between the simulation results and real data, and a frequency of occurrence of the value of the second calibration parameter.

The system may further include an input processor configured to receive a value of a third calibration parameter from a user after the simulating.

The calibration parameter value generating processor may generate a value of a fifth calibration parameter based on the initial data, the value of the second calibration parameter, and the value of the third calibration parameter when the value of the third calibration parameter is provided to the input processor, and the simulating processor may perform a simulation based on the value of the fifth calibration parameter.

The calibration parameter value generating processor may generate the value of the second calibration parameter based on results of comparison between simulation results and real data.

According to an embodiment of the present disclosure there is provided a system for calibrating a simulation model based on a framework, the system including: a calibration parameter value generating processor configured to generate a value of a second calibration parameter for calibrating a simulating processor; the simulating processor configured to simulate based on the value of the second calibration parameter; a displaying processor configured to visualize simulation results for the value of the second calibration parameter; and an input processor configured to receive a value of a third calibration parameter from a user after the simulating.

The calibration parameter value generating processor may generate a value of a fourth calibration parameter based on the value of the second calibration parameter and the value of the third calibration parameter when the value of the third calibration parameter is provided to the input processor, and the simulating processor may perform a simulation based on the value of the fourth calibration parameter.

According to an embodiment of the present disclosure there is provided a method for calibrating a simulation model based on a framework, the method including: generating a value of a first calibration parameter for calibrating microdata and a value of a second calibration parameter for calibrating a simulating processor; determining a missing value of the microdata based on the value of the first calibration parameter to generate initial data; and performing a first simulation based on the initial data and the value of the second calibration parameter.

The generating the value of the first calibration parameter and the value of the second calibration parameter may determine the missing value as 0, a mean value of one column of the microdata, or a value having a highest occurrence frequency in one column of the microdata, according to the value of the first calibration parameter.

The method may further include visualizing simulation results for the value of the second calibration parameter by a displaying processor, after the performing the first simulation.

The method may further include generating a value of a fifth calibration parameter based on the initial data, the value of the second calibration parameter, and a value of a third calibration parameter when the value of the third calibration parameter is provided from a user, and performing a second simulation based on the value of the fifth calibration parameter, after the visualizing.

The visualizing may visualize a vector value of the second calibration parameter, accuracy based on results of comparison between the simulation results and real data, and a frequency of occurrence of the vector value of the second calibration parameter.

According to an embodiment of the present disclosure there is provided an apparatus for calibrating a simulation model based on a framework, the apparatus including: a processor and a memory, wherein the processor executes a program stored in the memory to perform: generating a value of a first calibration parameter for calibrating microdata and a value of a second calibration parameter for calibrating a simulating processor; determining a missing value of the microdata based on the value of the first calibration parameter to generate initial data; and performing a first simulation based on the initial data and the value of the second calibration parameter.

When the generating the value of the first calibration parameter and the value of the second calibration parameter, the processor may perform determining the missing value as 0, a mean value of one column of the microdata, or a value having a highest occurrence frequency in one column of the microdata, according to the value of the first calibration parameter.

The apparatus may include a user interface output device including a displaying processor, wherein after the performing the first simulation, the processor performs visualizing simulation results for the value of the second calibration parameter through the user interface output device.

The apparatus may include a user interface input device including an input processor, wherein when a value of a third calibration parameter is input from a user to the user interface input device, the processor performs generating a value of a fifth calibration parameter based on the initial data, the value of the second calibration parameter, and the value of the third calibration parameter, and performing a second simulation based on the value of the fifth calibration parameter.

When the visualizing, the processor performs visualizing the value of the second calibration parameter, accuracy based on results of comparison between the simulation results and real data, and a frequency of occurrence of the value of the second calibration parameter through the user interface output device.

### BRIEF DESCRIPTION OF THE DRAWINGS

FIG. 1 is a block diagram illustrating a system for calibrating a simulation model using an integrated calibration method according to an exemplary embodiment.

FIG. 2 is a table illustrating microdata according to an exemplary embodiment.

FIG. 3 is a table illustrating initial data generated based on a value of a first calibration parameter according to an exemplary embodiment.

FIG. 4 is a block diagram illustrating a system for calibrating a simulation model based on an interactive calibration framework according to an exemplary embodiment.

FIG. 5 illustrates a screen of a displaying processor according to an exemplary embodiment.

FIG. 6 is a graph illustrating simulation results according to an exemplary embodiment.

FIG. 7 is a block diagram illustrating a system for calibrating a simulation model based on an integrated and iterative calibration framework according to an exemplary embodiment.

FIG. 8 is a table illustrating microdata of a simulation for predicting housing price and housing volume according to an exemplary embodiment.

FIG. 9 is a graph illustrating results of a simulation for predicting housing price and housing volume according to an exemplary embodiment.

FIG. 10 illustrates a screen showing results of a simulation for predicting housing price and housing volume according to an exemplary embodiment.

FIG. 11 is a flowchart illustrating a method for calibrating a simulation model according to an exemplary embodiment.

FIG. 12 is a block diagram illustrating an apparatus for calibrating a simulation model according to an exemplary embodiment.

### DETAILED DESCRIPTION OF THE EMBODIMENTS

Hereinafter, exemplary embodiments of the present disclosure will be described in detail with reference to the accompanying drawings so that those skilled in the art may easily practice the present disclosure. However, the present disclosure may be modified in various different ways and is not limited to embodiments described herein. In the accompanying drawings, portions unrelated to the description will be omitted in order to obviously describe the present disclosure, and similar reference numerals will be used to describe similar portions throughout the present specification.

Throughout the present specification and the claims, unless explicitly described to the contrary, the word “comprise” and variations such as “comprises” or “comprising” will be understood to imply the inclusion of stated elements but not the exclusion of any other elements.

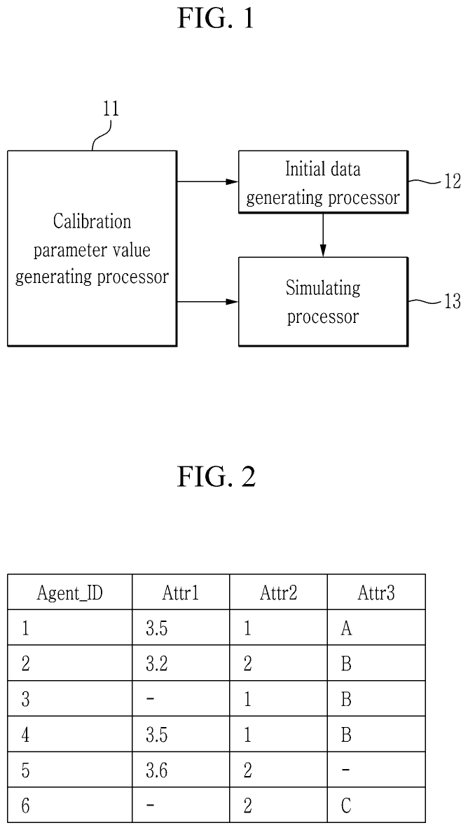

FIG. 1 is a block diagram illustrating a system for calibrating a simulation model using an integrated calibration method according to an exemplary embodiment.

Referring to FIG. 1, a system for calibrating a simulation model according to an exemplary embodiment includes a calibration parameter value generating processor 11, an initial data generating processor 12, and a simulating processor 13.

Initial data is required when performing simulation, and the initial data is generated based on microdata. The microdata have missing values. If the missing values are completely removed, the number of records of the microdata required for the initial data setting may be greatly reduced. If the missing values are replaced with arbitrary values, simulation results that a modeler (i.e., developer) or a user does not want may be generated. In order to solve this problem, the present invention includes an initial data generation process in a calibration area of the simulation model by extracting calibration parameters in the initial data generation process.

The calibration parameter value generating processor 11 generates a value of a first calibration parameter for calibrating microdata and a value of a second calibration parameter for calibrating the simulating processor 13.

The initial data generating processor 12 determines a missing value in the microdata based on the value of the first calibration parameter received from the calibration parameter value generating processor 11 to generate initial data. The first calibration parameter is not limited to the parameter for determining the missing value. Granularity of the initial data or the number of attributes in the initial data may be used as the first calibration parameter according to the simulation.

The microdata may be real microdata, and the first calibration parameter may be an initial data calibration parameter set by the modeler (or user). The initial data calibration parameter may take various forms depending on types of the initial data and characteristics of the simulation model. The initial data calibration parameter to be set by the modeler does not mean a value of a parameter for calibration, but mean variables. When the calibration parameter variable is determined by the modeler, the calibration parameter value generating processor 11 generates an optimum parameter value through a previously stored calibration process.

FIG. 2 is a table illustrating microdata according to an exemplary embodiment.

Referring to FIG. 2, in microdata for generating initial data of an agent-based simulation model, microdata of the Attr1 column has missing values of the third and sixth rows, and microdata of the Attr3 column has a missing value of the fifth row.

The initial data generating processor 12 may determines the missing value as one of 0, a mean value of one column of the microdata, or a value having a highest occurrence frequency in one column of the microdata, according to the value of the first calibration parameter to generate the initial data. For example, the initial data generating processor 12 may set Attr1, which is microdata having missing values, to IP 1 (which is the first calibration parameter). When a value of the first calibration parameter is 1 (i.e., when IP 1 is 1), the initial data generating processor 12 may set the missing values to 0. When IP 1 is 2, the initial data generating processor 12 may set the missing values to 3.5 (which is a mean value of Attr1). When IP 1 is 3, the initial data generating processor 12 may set the missing values to 3.5 (which is a value having a highest occurrence frequency in Attr1). The initial data generating processor 12 may set Attr3 to IP 2 which is a first calibration parameter, different from the first calibration parameter for Attr1. When IP 2 is 1, the initial data generating processor 12 may set the missing values to A (which is a default value of Attr3). When IP 2 is 2, the initial data generating processor 12 may set the missing values to B (which is a value having a highest occurrence frequency in Attr3).

The initial data generated by the initial data generating processor 12 is transmitted to the simulating processor 13.

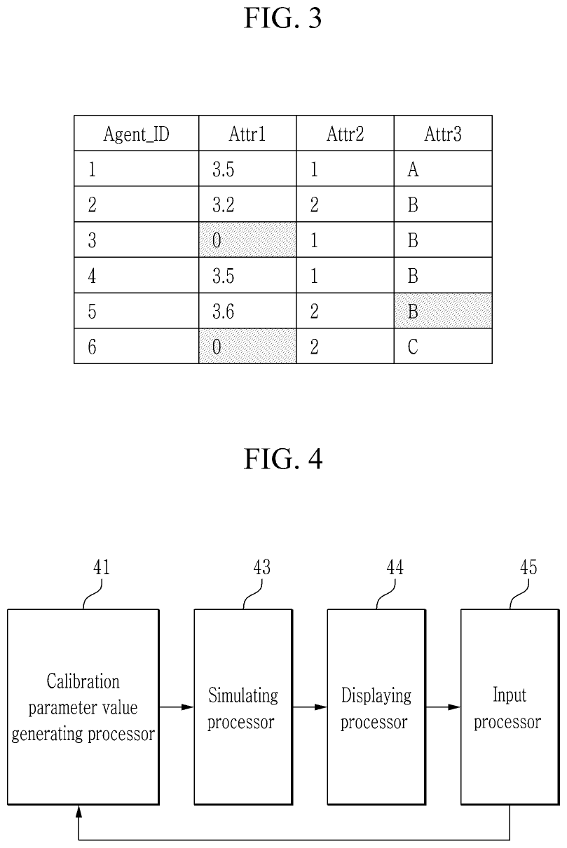

FIG. 3 is a table illustrating initial data generated based on a value of a first calibration parameter according to an exemplary embodiment.

Referring to FIG. 3, when IP 1 and IP 2 (which are the first calibration parameters) are 1 and 2, respectively, the missing value of Attr1 is set to 0, and the missing value of Attr3 is set to B.

There are various options in the process of generating initial data using different types of microdata such as Attr1 and Attr3 described above. Options that are considered when generating initial data may be set to parameters such that accuracy of calibration may be increased by using the parameters to calibrate the simulation model.

The calibration parameter value generating processor 11 generates the value of the second calibration parameter based on the second calibration parameter stored in advance. The second calibration parameter may be a model calibration parameter set by the modeler (or user). The model calibration parameter may be a calibration parameter of the type used in the existing calibration method. The value of the second calibration parameter may be a vector value for the second calibration parameter. If the number of model calibration parameters is m, the value of the second calibration parameter is as shown in Equation 1.

Pᵢ=(v₁, v₂, v₃, . . . , vₘ), [Equation 1]
where vⱼ∈{valid values of j-th calibration parameter}

The calibration parameter value generating processor 11 may generate P₁, . . . , Pₙ which are vector values of n second calibration parameters. The value of the second calibration parameter generated by the calibration parameter value generating processor 11 is transmitted to the simulating processor 13. The calibration parameter value generating processor 11 generates the value of the first calibration parameter stored in advance by the modeler (or user), and transmits the value of the first calibration parameter to the initial data generating processor 12.

The simulating processor 13 performs simulation based on the initial data and the value of the second calibration parameter. Specifically, the simulating processor 13 may perform the simulation based on the initial data and the value of the n second correction parameters.

After the simulation by the simulating processor 13, the calibration parameter value generating processor 11 performs an automatic calibration algorithm for comparing between simulation results and real data to select an optimum value of the second calibration. The automatic calibration algorithm may result in a local optimum due to the characteristics of the optimization technique. Because of this, the automatic calibration algorithm may have difficulty in providing the desired correction accuracy to the modeler.

A system for calibrating a simulation model using an integrated calibration method according to an exemplary embodiment may further include a memory module and a processor module. The system for calibrating a simulation model according to an exemplary embodiment can improve simulation performance of the processor.

FIG. 4 is a block diagram illustrating a system for calibrating a simulation model based on an interactive calibration framework.

A manual calibration is to calibrate the simulation model by the modeler (or user) by directly changing values of a calibration parameter, but it results in a long working time and complex tasks. A system for calibrating a simulation model based on an interactive calibration framework according to an exemplary embodiment is a hybrid type of system that combines automatic calibration and manual calibration.

Referring to FIG. 4, a system for calibrating a simulation model according to an exemplary embodiment includes a calibration parameter value generating processor 41, a simulating processor 43, a displaying processor 44, and an input processor 45.

The calibration parameter value generating processor 41 generates a value of a second calibration parameter for calibrating the simulating processor 43.

Since the value of the second calibration parameter is the same as the value of the second calibration parameter explained through the calibration parameter value generating processor 11, a detailed description will be omitted.

The value of the second calibration parameter generated by the calibration parameter value generating processor 41 is transmitted to the simulating processor 43.

The simulating processor 43 performs simulation based on the value of the second calibration parameter. The simulating processor 43 may perform the simulation based on the value of the n second correction parameters. Simulation results are transmitted to the displaying processor 44.

The displaying processor 44 visualizes the simulation results for the value of the second calibration parameter. The displaying processor 44 may be a calibration parameter status visualizer, and may be guide the modeler (or user) to generate a value of a new parameter. For example, the displaying processor 44 may visualize values of the calibration parameter that are already simulated and the results thereof, or may visualize information of values that are generated according to parameters.

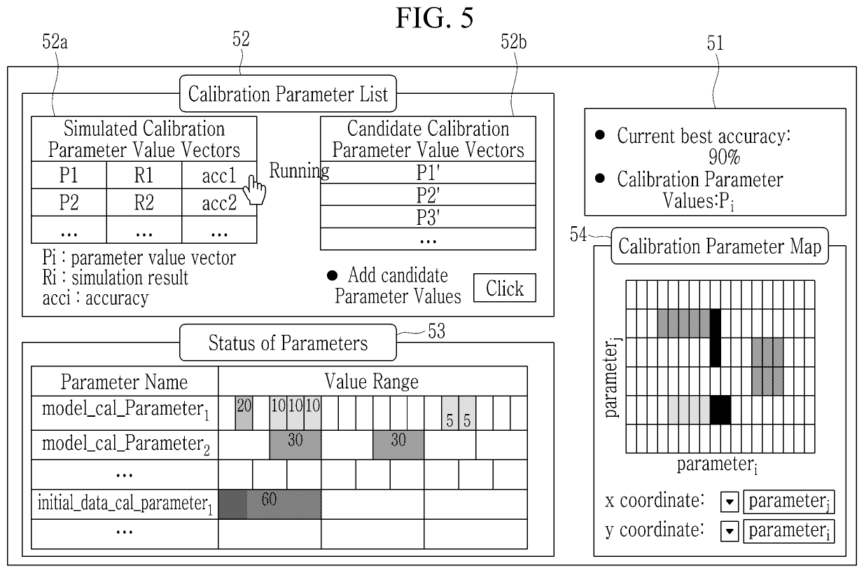

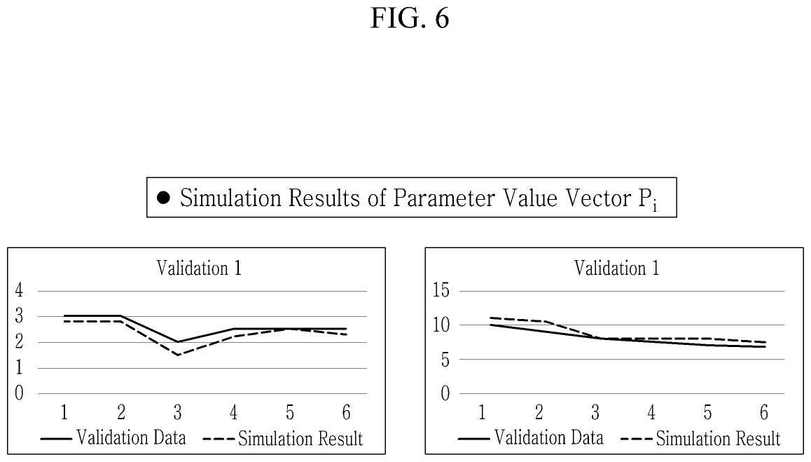

FIG. 5 illustrates a screen of a displaying processor according to an exemplary embodiment, and FIG. 6 is a graph illustrating simulation results according to an exemplary embodiment.

Referring to FIG. 5, the displaying processor 44 may visualize the value of the second calibration parameter, accuracy based on results of comparison between the simulation results and real data, and a frequency of occurrence of the value of the second calibration parameter.

Specifically, such as in an upper right screen 51, the displaying processor 44 may visualize the accuracy based on results of comparison between the simulation results and real data, and may visualize a vector value of the related calibration parameter.

Such as in a top left screen 52, the displaying processor 44 may visualize simulated calibration parameter value vectors and candidate calibration parameter value vectors. A vector value of the second calibration parameter Pi (which is already simulated), simulation results Ri, and accuracy acci may be displayed in a Simulated Calibration Parameter Value Vectors tab 52a. When the modeler (or user) clicks on the record of P1, the displaying processor 44 may visualize the detailed simulation results as shown in FIG. 6. Vector values of the candidate parameters to be simulated may be displayed in a Candidate Calibration Parameter Value Vectors tab 52b.

Such as in a lower left screen 53, the displaying processor 44 may visualize the Status of Parameters indicating the frequency of occurrence of the value of a calibration parameter. When a value of 0 is not generated in model_cal_parameter1 and a value is generated only in other parameters, a vector value of the calibration parameter may be made when model_cal_parameter1 is 0.

Such as in a bottom right screen 54, the displaying processor 44 may visualize the frequency of occurrence of the value of a calibration parameter, similar to the Status of Parameters. When the modeler (or user) selects two dimensions, the displaying processor 44 may visualize the frequency of occurrence of the value of a calibration parameter for the two dimensions.

The input processor 45 may receive a value of a third calibration parameter from the modeler (or user) after the simulation. The value of the third calibration parameter is a vector value of a new calibration parameter received from the modeler (or user). The modeler (or user) may add the vector value of the new calibration parameter through the input processor 45 after confirming the visualized screen in the displaying processor 44.

When the vector value of the new calibration parameter is not provided to the input processor 45, the displaying processor 44 may visualize a vector value having the highest accuracy among the vector values of the calibration parameters that is performed thus far, on the screen.

After the simulation, the calibration parameter value generating processor 41 selects a vector value of the calibration parameter having the highest accuracy with respect to the simulation results among vector values of all the calibration parameters. When the value of the third calibration parameter, which is the vector value of the new calibration parameter input by the modeler (or user), is not provided to the input processor 45, the calibration parameter value generating processor 41 may select a vector value of an n/2 calibration parameter, wherein the n is a natural number. When the value of the third calibration parameter, which is the vector value of the new calibration parameter input by the modeler (or user), is provided to the input processor 45, the calibration parameter value generating processor 41 may select a vector value of a (n−3k)/2 calibration parameter, wherein the n is a natural number.

The calibration parameter value generating processor 41 may generate a vector value of a new calibration parameter for each of the vector values of the calibration parameter selected above through the following process.

When the vector value of the selected calibration parameter is equal to Equation 2 when the value of the third calibration parameter, which is the vector value of the new calibration parameter input by the modeler (or user), is not provided,

Pᵢ=(v₁, v₂, . . . , vⱼ, . . . , vₘ) [Equation 2]

The calibration parameter value generating processor 41 may select an arbitrary calibration column j, and generate a vector value of the calibration parameter such as in Equation 3 for the selected j.

Pᵢ′=(v₁, v₂, . . . , vⱼ+dⱼ, . . . vₘ), Pᵢ″=(v₁, v₂, . . . , vⱼ−dⱼ, . . . , vₘ), [Equation 3]

where dⱼ=increment of j-th calibration parameter

When the simulating has already been performed on the vector value of the existing calibration parameter, the calibration parameter value generating processor 41 may generate another value j. Otherwise, the calibration parameter value generating processor 41 may add a vector value of the calibration parameter such as in Equation 4 to the vector value list of the calibration parameter to be newly simulated.

Pᵢ′=(v₁, v₂, . . . , vⱼ+dⱼ, . . . , vₘ), Pᵢ″=(v₁, v₂, . . . , vⱼ−dⱼ, . . . , vₘ) [Equation 4]

When the value of the third calibration parameter, which is the vector value of the new calibration parameter input by the modeler (or user), is provided to the input processor 45, the calibration parameter value generating processor 41 may generate a value of a fourth calibration parameter based on the value of the second calibration parameter and the value of the third calibration parameter, and the simulating processor 43 may perform a simulation based on the value of the fourth calibration parameter.

Specifically, when the vector value of the new calibration parameter input by the modeler (or user) (user-generated parameter value vector) is equal to Equation 1, the calibration parameter value generating processor 41 may select an arbitrary calibration column j, and generate a vector value of the calibration parameter such as in Equation 4 for the selected j.

When the simulating has already been performed on the vector value of the existing calibration parameter, the calibration parameter value generating processor 41 may generate another value j. Otherwise, the calibration parameter value generating processor 41 may add a vector value of the calibration parameter such as in Equation 5 to the vector value list of the calibration parameter to be newly simulated.

Pᵢ=(v₁, v₂, . . . , vⱼ, . . . , vₘ), Pᵢ′=(v₁, v₂, . . . , vⱼ+dⱼ, . . . , vₘ),

Pᵢ″=(v₁, v₂, . . . , vⱼ−dⱼ, . . . , vₘ) [Equation 5]

The calibration parameter value generating processor 41 may generate only one calibration column j at the time of generating the vector value of the calibration parameter as described above. In another exemplary embodiment, the calibration parameter value generating processor 41 may generate any two calibration columns j, k and generate a vector value of the calibration parameter such as in Equation 6.

Pᵢ′=(v₁, v₂, . . . , vⱼ+dⱼ, . . . , vₘ), Pᵢ″=(v₁, v₂, . . . , vⱼ−dₖ, . . . , vₘ) [Equation 6]

The system for calibrating a simulation model based on an interactive calibration framework according to an exemplary embodiment may further include a memory module and a processor module. The system for calibrating a simulation model based on an interactive calibration framework according to an exemplary embodiment can improve simulation performance of the processor.

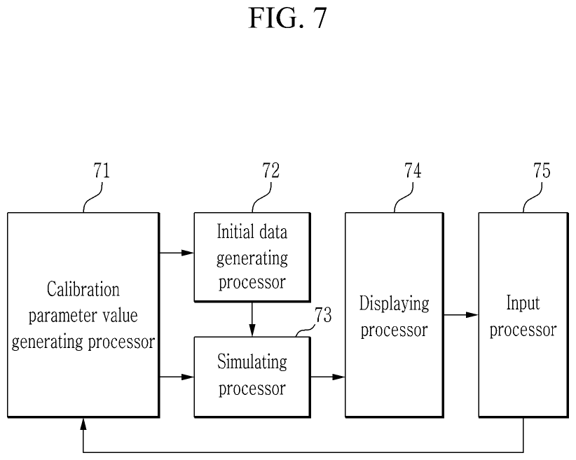

FIG. 7 is a block diagram illustrating a system for calibrating a simulation model based on an integrated and iterative calibration framework according to an exemplary embodiment.

Referring to FIG. 7, the system for calibrating a simulation model based on an integrated and iterative calibration framework according to an exemplary embodiment includes a calibration parameter value generating processor 71, an initial data generating processor 72, a simulating processor 73, a displaying processor 74, and an input processor 75.

The calibration parameter value generating processor 71 generates a value of a first calibration parameter for calibrating microdata and a value of a second calibration parameter for the calibrating simulating processor 73. Since the values of the first calibration parameter and the second calibration parameter are equal to the values of the first calibration parameter and the second calibration parameter described through the calibration parameter value generating processor 11 and the initial data generating processor 12, detailed description thereof will be omitted. The value of the first calibration parameter generated by the calibration parameter value generating processor 71 is transmitted to the initial data generating processor 72, and the value of the second calibration parameter generated by the calibration parameter value generating processor 71 is transmitted to the simulating processor 73.

The initial data generating processor 72 determines a missing value of the microdata based on the value of the first calibration parameter received from the calibration parameter value generating processor 71 to generate initial data. The initial data generating processor 72 may generate n initial data. Since the initial data generation module 72 is the same as the initial data generating processor 12 described above, detailed description of determining the missing value will be omitted.

The simulating processor 73 may perform simulation based on the n initial data and the value of the n second calibration parameters. Simulation results are transmitted to the displaying processor 74.

The displaying processor 74 visualizes the simulation results for the value of the second calibration parameter. The modeler (or user) may stop the calibration operation after performing various analyses through the displaying processor 74, or may perform the simulation again by adding the value of the third calibration parameter, which is the vector value of the new calibration parameter, or may perform the simulation again without adding the vector value of the new calibration parameter.

The displaying processor 74 is the same as the displaying processor 44 described above, so detailed description thereof will be omitted.

The input processor 75 may receive a value of a third calibration parameter from the modeler (or user) after the simulation. Since the input processor 75 is the same as the input processor 45 described above, detailed description thereof will be omitted.

After the simulation, the calibration parameter value generating processor 71 may generate a value of a fifth calibration parameter based on the initial data, the value of the second calibration parameter, and the value of the third calibration parameter when the value of the third calibration parameter is provided to the input processor 75. Specifically, the calibration parameter value generating processor 71 may generate the value of the fifth calibration parameter such as in Equation 7 based on the initial data, the value of the second calibration parameter, and the value of the third calibration parameter.

Pᵢ=(model_cal_parameter₁, model_cal_parameter₂, . . . , initial_data_cal_parameter₁, initial_data_cal_parameter₂, . . . ) [Equation 7]

The simulating processor 73 performs simulation based on the value of the fifth calibration parameter.

The system for calibrating a simulation model based on an integrated and iterative calibration framework according to an exemplary embodiment may further include a memory module and a processor module. The system for calibrating a simulation model based on an integrated and iterative calibration framework according to an exemplary embodiment can improve simulation performance of the processor.

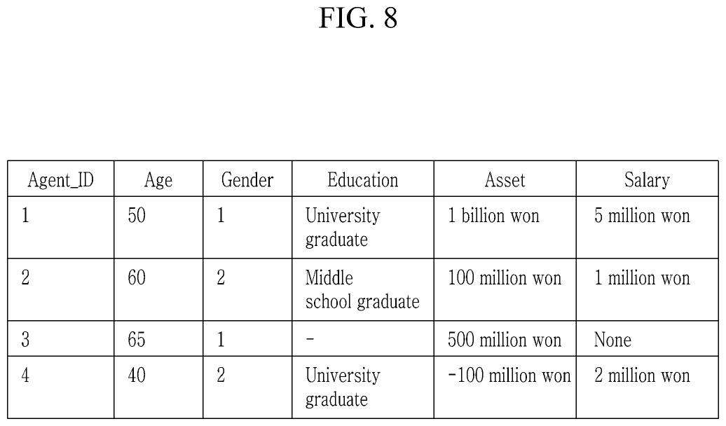

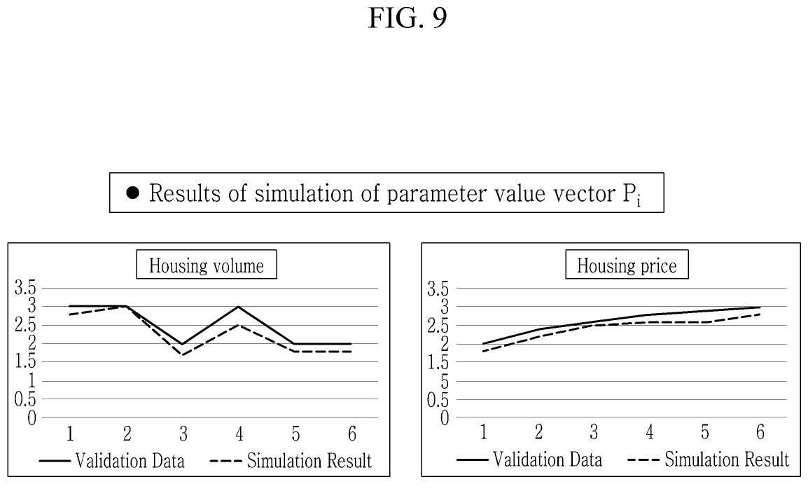

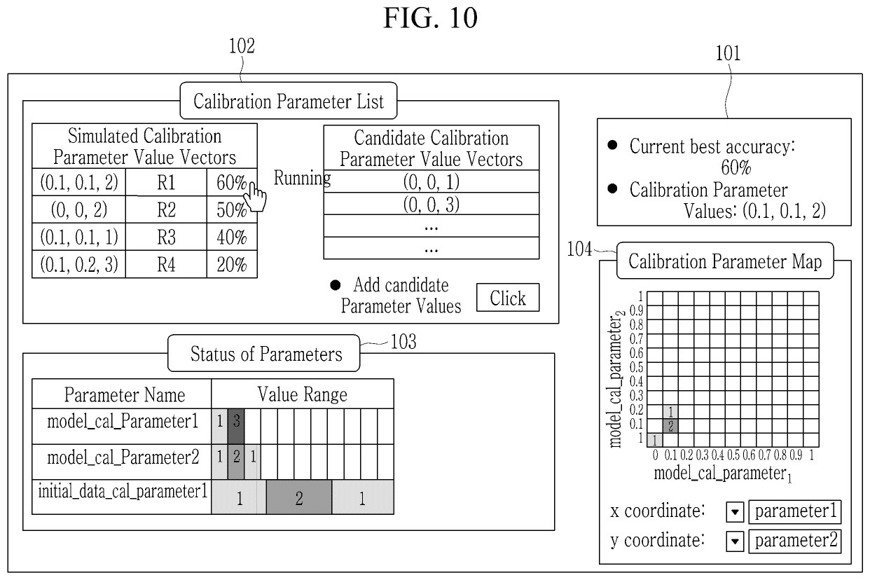

FIG. 8 is a table illustrating microdata of a simulation for predicting housing price and housing volume according to an exemplary embodiment, FIG. 9 is a graph illustrating results of a simulation for predicting housing price and housing volume according to an exemplary embodiment, and FIG. 10 illustrates a screen showing results of a simulation for predicting housing price and housing volume according to an exemplary embodiment.

In order to generate initial data of each agent in the agent-based housing price and housing volume prediction simulation, microdata is required. The microdata for the simulation for predicting housing price and housing volume is shown in FIG. 8.

Referring to FIG. 8, among the Age, Gender, Education, Asset, and Salary columns, microdata of the Education column has a missing value of the third row. According to the system for calibrating a simulation model based on an integrated and iterative calibration framework, the calibration parameter value generating processor 71 may generate a value of a first calibration parameter which is set to initial_data_cal_parameter1 by the modeler (or user) and a value of a second calibration parameter for the calibrating simulating processor 73. The initial data generating processor 72 may determine a missing value of the microdata based on the value of the initial_data_cal_parameter1 (i.e., the value of the first calibration parameter) received from the calibration parameter value generating processor 71. When the value of initial_data_cal_parameter1 which is the first calibration parameter, is 1, the initial data generating processor 72 may set the missing value to a university graduate, which is the highest occurrence frequency in the Education column. When the value of initial_data_cal_parameter1 is 2, the initial data generating processor 72 may set the missing value to an elementary school graduate, which is a default value in the Education column. When the value of initial_data_cal_parameter1 is 3, the initial data generating processor 72 may set the missing value to lower than the elementary school graduate when the age is over 60 years old, may set the missing value to a high school graduate when the age is over 40 years old, and may set the missing value to a university graduate when the age is over 25 years old.

In a simulation model for predicting housing price and housing volume, the probability of purchasing a house in the metropolitan area (model_cal_parameter1) and the probability of buying a house in a non-metropolitan area (model_cal_parameter2) may be set as model calibration parameters. The model_cal_parameter1 and the model_cal_parameter2 may include {0, 0.1, 0.2, . . . , 1}. The scale of the model_cal_parameter1 and the model_cal_parameter2 may vary depending on the setting. The simulating processor 73 may perform simulation based on the initial data and the value of the second calibration parameter.

Referring to FIG. 9, the displaying processor 74 may output the results of a simulation for predicting housing price and housing volume indicating the housing volume and the housing price by steps.

A method for calculating accuracy of the simulation is shown in Equation 8.

$${\sum }_{i} \{ {( {Volume}_{i} - {Volume}_{i}^{′} )}^{2} + {( {Price}_{i} - {Price}_{i}^{′} )}^{2} \} \qquad [ Equation 8 ]$$

Volume; represents the real estate volume in an i step, Volumeᵢ′

represents the simulated housing volume in the i step, Priceᵢ represents the real housing price in the i step, and Priceᵢ′ represents the simulated housing price in the i step.

If the vector value of the calibration parameter generated by the calibration parameter value generating processor 71 after the simulation is equal to Equation 9, the displaying processor 74 outputs a screen as shown in FIG. 10.

(Pᵢ=(model_cal_parameter1, model_cal_parameter2, initial_data_cal_parameter1))

P₁=(0, 0, 2)

P₂=(0.1, 0.1, 2)

P₃=(0.1, 0.1, 1)

P₄=(0.1, 0.2, 3)

Referring to FIG. 10, a frequency of occurrence of each vector value of each calibration parameter may be displayed in a Status of Parameters tab 103. Since a frequency of occurrence of 0 is 1 and a frequency of occurrence of 0.1 is 3 in the model_cal_parameter1 the frequency of occurrence may be displayed as the tab 103. The frequencies of occurrence of the model_cal_parameter1 and the model_cal_parameter2 may be simultaneously displayed on a Calibration Parameter Map tab 104. Since the frequency of occurrence is 2 when the values of the model_cal_parameter1 and model_cal_parameter2 are 0.1, 2 indicating the frequency of occurrence may be displayed in the tab 104.

The input processor 75 may receive a value of a third calibration parameter from the modeler (or user) after the simulation. After the simulation, the calibration parameter value generating processor 71 may generate a value of a fifth calibration parameter based on the initial data, the value of the second calibration parameter, and the value of the third calibration parameter when the value of the third calibration parameter is provided to the input processor 75.

The system and method for calibrating a simulation model according to the present invention may be applied not only to the housing described above, but also to real estate such as land and various other simulation fields.

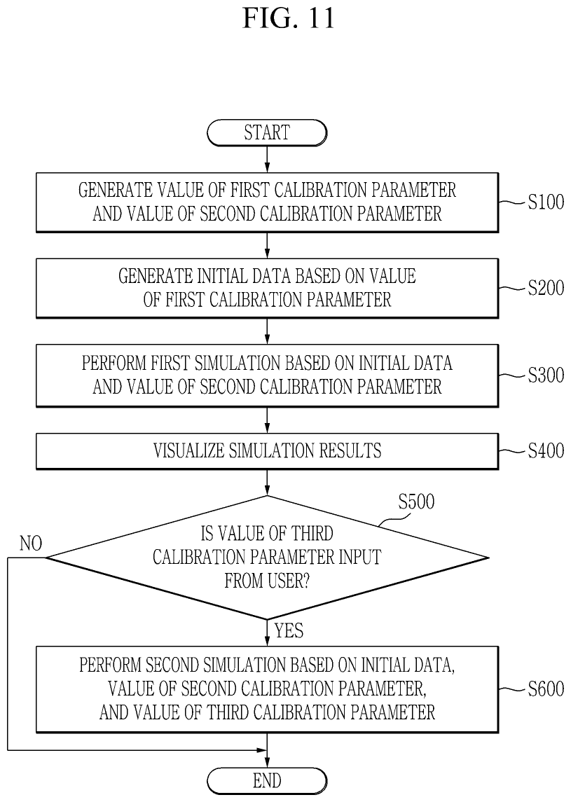

FIG. 11 is a flowchart illustrating a method for calibrating a simulation model according to an exemplary embodiment.

Referring to FIG. 11, a method for calibrating a simulation model according to an exemplary embodiment includes generating a value of a first calibration parameter for calibrating microdata and a value of a second calibration parameter for calibrating a simulating processor (S100), determining a missing value of the microdata based on the value of the first calibration parameter to generate initial data (S200), and performing a first simulation based on the initial data and the value of the second calibration parameter (S300).

The generating the value of the first calibration parameter and the value of the second calibration parameter (S100) may determine the missing value as 0, a mean value of one column of the microdata, or a value having a highest occurrence frequency in one column of the microdata, according to the value of the first calibration parameter.

After the performing the first simulation (S300), the method may further include visualizing simulation results for the value of the second calibration parameter by a displaying processor (S400).

After the visualizing (S400), the method may further include generating a value of a fifth calibration parameter based on the initial data, the value of the second calibration parameter, and a value of a third calibration parameter when the value of the third calibration parameter is provided from a user (S500), and performing a second simulation based on the value of the fifth calibration parameter (S600). The second simulation (S600) may not be performed only once, but may be repeated several thousands of times in some cases. If the user intervenes in the process of repeating the simulation, the third calibration parameter may be included. If the user does not intervene, the third calibration parameter may not be included. Because the simulation process takes a long time, the user may check the calibration status through the UI and intervene in the middle.

The visualizing (S400) may visualize a plurality of vector values of the second calibration parameter, accuracy based on results of comparison between the simulation results and real data, and a frequency of occurrence of the vector value of the second calibration parameter.

The generating the value of the first calibration parameter and the value of the second calibration parameter (S100), the generating initial data (S200), the performing a first simulation (S300), the visualizing the simulation results (S400), and the performing a second simulation (S600) are the same as the operating of the calibration parameter value generating processors 11, 41, and 71, the initial data generating processors 12 and 72, the simulating processors 13, 43, and 73, the displaying processors 44 and 74, and the input processors 45 and 75, so detailed description will be omitted.

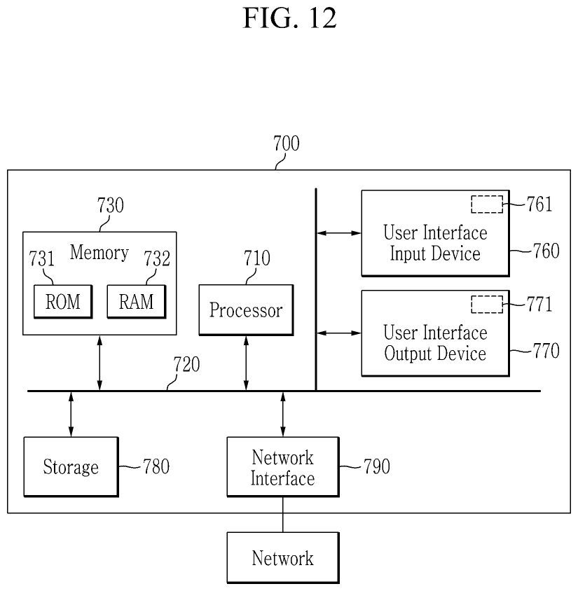

FIG. 12 is a block diagram illustrating an apparatus for calibrating a simulation model according to an exemplary embodiment.

An apparatus for calibrating a simulation model according to an exemplary embodiment may be implemented in a computer system, e.g., as a computer readable medium. As shown in in FIG. 12, a computer system 700 may include one or more of a processor 710, a memory 730, a user interface input device 760, a user interface output device 770, and a storage 780, each of which communicates through a bus 720. The computer system 700 may also include a network interface 790 that is coupled to a network. The processor 710 may be a central processing unit (CPU) or a semiconductor device that executes processing instructions stored in the memory 730 and/or the storage 780. The memory 730 and the storage 780 may include various forms of volatile or non-volatile storage media. For example, the memory may include a read-only memory (ROM) 731 and a random access memory (RAM) 732. Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

The apparatus for calibrating a simulation model according to an exemplary embodiment includes the processor 710 and the memory 730, the processor 710 executes a program stored in the memory to generate a value of a first calibration parameter for calibrating microdata and a value of a second calibration parameter for calibrating a simulating processor, determine a missing value of the microdata based on the value of the first calibration parameter to generate initial data, and perform a first simulation based on the initial data and the value of the second calibration parameter.

When generating the value of the first calibration parameter and the value of the second calibration parameter, the processor 710 may determine the missing value as 0, a mean value of one column of the microdata, or a value having a highest occurrence frequency in one column of the microdata, according to the value of the first calibration parameter.

The user interface output device 770 may include a displaying processor 771. After the performing of the first simulation, the processor 710 may perform visualizing simulation results for the value of the second calibration parameter through the user interface output device 770.

The user interface input device 760 may include an input processor 761. When a value of a third calibration parameter is input from a user to the user interface input device 760, the processor 710 may generate a value of the fifth calibration parameter based on the initial data, the value of the second calibration parameter, and the value of the third calibration parameter, and perform a second simulation based on the value of the fifth calibration parameter.

When the visualizing, the processor 710 may perform visualizing of the value of the second calibration parameter, accuracy based on results of comparison between the simulation results and real data, and a frequency of occurrence of the value of the second calibration parameter through the user interface output device 770.

The user interface input device 760 may receive the value of the first calibration parameter and the value of the second calibration parameter from the modeler (or user). The storage 780 may store the microdata, the value of the first calibration parameter, and the value of the second calibration parameter.

Simulation performance of the processor 710 of the apparatus for calibrating a simulation model can be improved by performing the generating a value of a first calibration parameter for calibrating microdata and a value of a second calibration parameter for calibrating the simulating processor, the determining a missing value of the microdata based on the value of the first calibration parameter to generate initial data, and the performing a first simulation based on the initial data and the value of the second calibration parameter.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A system for calibrating a simulation model based on a framework, comprising:
a calibration parameter value generating processor configured to generate a value of a first calibration parameter for calibrating microdata and a value of a second calibration parameter for calibrating a simulating processor;
an initial data generating processor configured to determine a missing value of the microdata based on the value of the first calibration parameter to generate initial data; and
the simulating processor configured to simulate based on the initial data and the value of the second calibration parameter.

2. The system of claim 1, wherein the initial data generating processor determines the missing value as one of 0, a mean value of one column of the microdata, or a value having a highest occurrence frequency in one column of the microdata, according to the value of the first calibration parameter.

3. The system of claim 1, further comprising a displaying processor configured to visualize simulation results for the value of the second calibration parameter.

4. The system of claim 3, wherein the displaying processor visualizes the value of the second calibration parameter, accuracy based on results of comparison between the simulation results and real data, and a frequency of occurrence of the value of the second calibration parameter.

5. The system of claim 1, further comprising an input processor configured to receive a value of a third calibration parameter from a user after the simulating.

6. The system of claim 5, wherein:
the calibration parameter value generating processor generates a value of a fifth calibration parameter based on the initial data, the value of the second calibration parameter, and the value of the third calibration parameter when the value of the third calibration parameter is provided to the input processor, and
the simulating processor performs a simulation based on the value of the fifth calibration parameter.

7. The system of claim 1, wherein the calibration parameter value generating processor generates the value of the second calibration parameter based on results of comparison between simulation results and real data.

8. A system for calibrating a simulation model based on a framework, comprising:
a calibration parameter value generating processor configured to generate a value of a second calibration parameter for calibrating a simulating processor;
the simulating processor configured to simulate based on the value of the second calibration parameter;
a displaying processor configured to visualize simulation results for the value of the second calibration parameter; and
an input processor configured to receive a value of a third calibration parameter from a user after the simulating.

9. The system of claim 8, wherein:
the calibration parameter value generating processor generates a value of a fourth calibration parameter based on the value of the second calibration parameter and the value of the third calibration parameter when the value of the third calibration parameter is provided to the input processor, and
the simulating processor performs a simulation based on the value of the fourth calibration parameter.

10. A method for calibrating a simulation model based on a framework, comprising:
generating a value of a first calibration parameter for calibrating microdata and a value of a second calibration parameter for calibrating a simulating processor;
determining a missing value of the microdata based on the value of the first calibration parameter to generate initial data; and
performing a first simulation based on the initial data and the value of the second calibration parameter.

11. The method of claim 10, wherein the generating the value of the first calibration parameter and the value of the second calibration parameter determines the missing value as 0, a mean value of one column of the microdata, or a value having a highest occurrence frequency in one column of the microdata, according to the value of the first calibration parameter.

12. The method of claim 10, further comprising visualizing simulation results for the value of the second calibration parameter by a displaying processor, after the performing the first simulation.

13. The method of claim 12, further comprising generating a value of a fifth calibration parameter based on the initial data, the value of the second calibration parameter, and a value of a third calibration parameter when the value of the third calibration parameter is provided from a user, and performing a second simulation based on the value of the fifth calibration parameter, after the visualizing.

14. The method of claim 12, wherein the visualizing visualizes a vector value of the second calibration parameter, accuracy based on results of comparison between the simulation results and real data, and a frequency of occurrence of the vector value of the second calibration parameter.

15. An apparatus for calibrating a simulation model based on a framework, comprising:
a processor and a memory,
wherein the processor executes a program stored in the memory to perform:
generating a value of a first calibration parameter for calibrating microdata and a value of a second calibration parameter for calibrating a simulating processor;
determining a missing value of the microdata based on the value of the first calibration parameter to generate initial data; and
performing a first simulation based on the initial data and the value of the second calibration parameter.

16. The apparatus of claim 15, wherein when the generating the value of the first calibration parameter and the value of the second calibration parameter, the processor performs determining the missing value as 0, a mean value of one column of the microdata, or a value having a highest occurrence frequency in one column of the microdata, according to the value of the first calibration parameter.

17. The apparatus of claim 15, further comprising a user interface output device including a displaying processor,
wherein after the performing the first simulation, the processor performs visualizing simulation results for the value of the second calibration parameter through the user interface output device.

18. The apparatus of claim 17, further comprising a user interface input device including an input processor,
wherein when a value of a third calibration parameter is input from a user to the user interface input device, the processor performs generating a value of a fifth calibration parameter based on the initial data, the value of the second calibration parameter, and the value of the third calibration parameter, and performing a second simulation based on the value of the fifth calibration parameter.

19. The apparatus of claim 17, wherein when the visualizing, the processor performs visualizing the value of the second calibration parameter, accuracy based on results of comparison between the simulation results and real data, and a frequency of occurrence of the value of the second calibration
parameter through the user interface output device.
